(19) United States
(12) Patent Application Publication
(10) Pub. No.: US 2026/0309316 A1
(43) Pub. Date: Oct. 8, 2026

(54) BREAKAWAY BANDS FOR TREE LIGHTING AND A TREE LIGHTING SYSTEM INCLUDING A LIGHT STRING WITH ONE OR MORE BREAKAWAY BANDS

(71) Applicant: DeZaio Productions, Inc., Fair Lawn, NJ (US)

(72) Inventor: Michael DeZaio, Ridgewood, NJ (US)

(21) Appl. No.: 19/630,889

(22) Filed: Mar. 27, 2026

Related U.S. Application Data
(60) Provisional application No. 63/782,674, filed on Apr. 3, 2025.

(51) Int. Cl. F21V 23/00; F21S 4/10; F21V 23/06; F21W 121/00; F21Y 115/10

(52) U.S. Cl. CPC F21V 23/001; F21S 4/10; F21V 23/06; F21W 2121/004; F21Y 2115/10

(57) ABSTRACT

A tree lighting system including a light string and a breakaway band, wherein the light string has a length, the light string includes power wires connecting a plurality of light sockets, the plurality of light sockets configured to hold and provide power from the power wires to a respective plurality of light elements configured to emit light when powered, wherein the breakaway band is disposed about the power wires at a predetermined distance below a light socket of the plurality of light sockets, thus providing a slack portion between the breakaway band and the light socket, the slack portion reducing the length of the light string, the breakaway band including at least one perforation that upon exertion of force breaks and is configured to allow the slack portion to splay thus extending the light string toward its length.

### CROSS-REFERENCE TO RELATED APPLICATIONS

This application claims the benefit of priority to U.S. Provisional Patent Application Serial No. 63/782,674, filed Apr. 3, 2025, the entire content of which is incorporated herein by reference.

### BACKGROUND

### Field

The present application relates generally to tree lighting. More specifically, the present application is directed to breakaway bands for tree lighting and a tree lighting system that includes one or more light strings, each with one or more breakaway bands to provide expandability of the light strings.

### Brief Discussion of Related Art

Live trees whether disposed indoors and/or outdoors can be decorated to produce lighting in desired indoor and/or outdoor locations, for aesthetics, holidays, or other reasons. Tree lighting includes a light string that is applied to or wrapped about a tree for decorative purposes, including ambiance, holidays, esthetics, etcetera. In particular, the light string includes a length of electrical conductor(s) with multiple light sockets along the length that include light devices, which can provide light along the light string. The light string can be of various types which can be plugged into conventional electrical wall outlets or ones that are plugged into a universal serial bus (USB) ports.

Particularly with the implementation of light emitting diodes (LEDs) and/or other lightening technologies that provide a multiplicity of hours of use, tree lighting applied to or wrapped about trees can now be used for long durations, such as many years and/or multiple seasons without being removed. In the first instance of being applied to a tree, the light string is placed in a generally taut disposition about the tree so that the lighting string can be appropriately positioned and prevented from drooping. As the live tree grows over multiple seasons and/or multiple years, the increasing circumference of the tree can cause the light string to embed into the outer bark of the tree, and with more time into the inner bark, and then the cambium of the tree that is the growing part of the tree producing new wood and bark. As a result, the ever-further embedded light string associated with tree growth can injure or kill the tree, can damage or break the light string itself, and can further make the removal of the embedded light string significantly more difficult.

Various elastic and/or stretchable type elements have been proposed over the years, wherein in a first state, one or more of the elements in a contracted state are attached to portions of the light string and allow these portions to have slack while reducing the overall length of the light string, so that the light string can be mounted to the tree in a generally taut disposition so that the lighting string can be appropriately positioned and prevented from drooping, and wherein in one or more second states as the tree grows, the one or more elements let out the slack of the light string as they stretch, thus lengthening the overall length of the light string and allowing the light string to continue being mounted to the tree in a generally taut disposition about the tree so that the lighting string can continue to be appropriately positioned and prevented from drooping.

The foregoing elastic and/or stretchable type elements are generally costly to manufacture, might require intricate or difficult assembly with the light string, and thus make it more time-consuming and laborious to install the tree lighting to the tree. Such increased cost, assembly delay, and installation inefficiency combine to reduce the desirability of these elements in the installation of light strings.

It is therefore desirable to provide a system including one or more elements that are inexpensive to manufacture, simple and reliable to install, provide for efficiency in a method of installation of the light string, and allow portions of the light string to have slack while reducing the overall length of the light string so that the light string can be initially mounted or installed to the tree in a taut arrangement and further allow the light string to expand as the tree grows over multiple seasons, without injuring the tree or requiring significant labor to remove the light string after the multiple seasons.

### SUMMARY

There are provided breakaway bands for tree lighting and a tree lighting system that includes one or more light strings each with one or more breakaway bands to provide expandability of the light strings.

In accordance with an embodiment or aspect, there is disclosed a tree lighting system including a light string and a breakaway band. The light string has a length, the light string includes power wires connecting a plurality of light sockets, the plurality of light sockets configured to hold and provide power from the power wires to a respective plurality of light elements configured to emit light when powered. The breakaway band is disposed about the power wires at a predetermined distance below a light socket of the plurality of light sockets, thus providing a slack portion of the power wires between the breakaway band and the light socket. The slack portion reduces the length of the light string. The breakaway band includes at least one perforation that upon exertion of force breaks and is configured to allow the slack portion to splay thus extending the light string toward its length.

In some cases, the light string is configured to be disposed about a live tree. The live tree exerts the force on the at least one perforation of the breakaway band.

In some cases, the at least one perforation of the breakaway band can include one perforation. In some other cases, the at least one perforation of the breakaway band can include three perforations.

In some cases, the three perforations are equidistantly spaced along the breakaway band.

In some cases, a light element is a lightbulb or a light emitting diode.

In some cases, the breakaway band can include an adhesive disposed at one or more portions of the breakaway band so that the breakaway band is capable of being secured about the power wires at the predetermined distance below the light socket.

In some cases, the breakaway band includes a removable cover configured to expose the adhesive disposed at the one or more portions.

In some cases, the breakaway band has a length and a width. The length can be in a range of ½ of an inch to 2½ inches, and the width can be in a range of ⅛ of an inch to ½ of an inch.

In some cases, the breakaway band has a thickness. The thickness can be in a range of 1 mil. to 3.5 mil.

In some cases, the breakaway band is made of polyvinyl chloride, thermoplastic, rubber, plastic film, paper, or cloth.

In accordance with an embodiment or aspect, there is disclosed a breakaway band for a tree lighting string including power wires connecting a plurality of light sockets, the plurality of light sockets configured to hold and provide power from the power wires to a respective plurality of light elements configured to emit light when powered, the breakaway band having a length and a width, the breakaway band including at least one perforation and an adhesive. The at least one perforation extends along the width and located centrally along the length. The adhesive is disposed at one or more portions along the length of the breakaway band, so that the breakaway band is capable of being secured about the power wires at a predetermined distance below a light socket providing a slack portion of the power wires between the breakaway band and the light socket, wherein upon exertion of force to the at least one perforation the breakaway band is configured to break thus allowing the slack portion to splay and extend the light string.

In some cases, the breakaway band can include a removable cover configured to expose the adhesive disposed at the one or more portions.

In some cases, the length is in a range of ½ of an inch to 2½ inches, and the width is in a range of ⅛ of an inch to ½ of an inch.

In some cases, the breakaway band has thickness in a range of 1 mil. to 3.5 mil.

In some cases, the at least one perforation of the breakaway band includes three perforations. The three perforations can be equidistantly spaced along the length of the breakaway band.

These and other purposes, goals and advantages of the present application will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings in which:

FIG. 1 illustrates a tree lighting system that includes at least one light string with one or more breakaway bands applied to wiring below associated one or more lights (e.g., below light sockets for holding lamps or LEDs) to thus provide expandability of the at least one light string about a live tree;

FIG. 2 illustrates a close-up view of a breakaway bands respectively according to the first and second embodiments, as applied to wiring below an associated lights of the light strings in accordance with FIG. 1;

FIG. 3 illustrates an exploded view of several breakaway bands according to the first and second embodiments, being applied to the wiring of associated lights (e.g., light sockets holding lightbulbs/LEDs) of the at least one light string in accordance with FIG. 1;

FIGS. 4A-4D illustrate the operation of the breakaway band according to the first embodiment, as applied to the wiring of an associated light (e.g., light socket) of the at least one light string in accordance with FIGS. 1-3;

FIGS. 5A-5D illustrate the operation of the breakaway band according to the second embodiment, as applied to the wiring of an associated light (e.g., light socket) of the at least one light string in accordance with FIGS. 1-3;

FIGS. 6A-6C illustrate a breakaway band according to the first embodiment or the second embodiment, with an adhesive disposed on at least one portion of the breakaway band configured to allow the breakaway band to be securely attached about the wiring of an associated light (light socket) of the at least one light string in accordance with FIGS. 1-5D; and

FIG. 7 illustrates a breakaway band according to the first embodiment or the second embodiment, with an adhesive disposed on at least a portion of the breakaway band configured to allow the breakaway band to be securely attached about the wiring of an associated light (light socket) of the at least one light string in accordance with FIGS. 1-5D, and a removable cover configured to expose the adhesive when affixing the breakaway band to the wiring of an associated light (light socket).

### DETAILED DESCRIPTION

There are disclosed herein breakaway bands for tree lighting and a tree lighting system that includes one or more light strings each with one or more breakaway bands to provide expandability of the light strings. In the following description, for the purposes of explanation, numerous specific details are set forth to provide a thorough understanding of example embodiments or aspects. It will be evident, however, to one skilled in the art, that an example embodiment may be practiced without all the disclosed specific details.

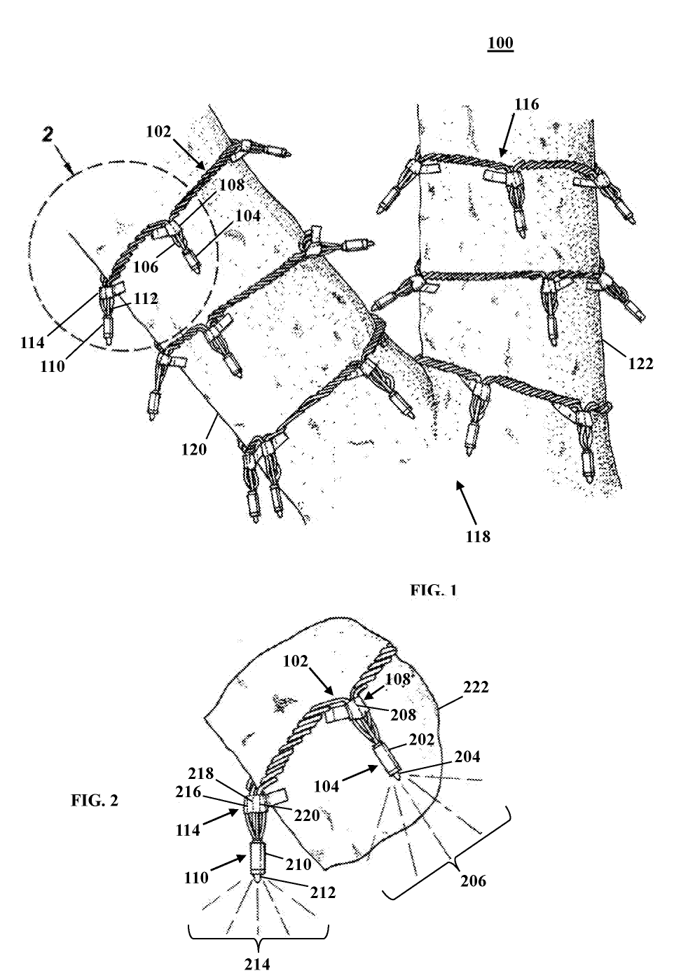

FIG. 1 illustrates a tree lighting system 100 that includes at least one light string 102, 116 with one or more breakaway bands 108, 114 applied to wiring 106, 112 below associated one or more light elements 104, 110 (e.g., below a light socket for holding a lamp or a light emitting diode (LED)) to thus provide expandability of the at least one light string 102, 116 about a live tree 118. The live tree can have a trunk 112 and one or more branches 120 about which the one or more light string 102, 116 can be disposed.

In particular, the one or more light string 102, 116 can be connected in series (e.g., a first end of the light string 102 can be plugged into a wall outlet (not shown), extension cord (not shown), or a USB connection (not shown), which provide power and a second end of the light string 102 can connect to a first end of the second light string 116). Accordingly, the one or more light elements 104, 110 of the strings 102, 116 can thus be lit.

Alternatively, the lights strings 102, 116 can be independently connected to the same or different wall outlets (not shown), extension cords (not shown), or USB connections (not shown) to receive power. Accordingly, the one or more light elements 104, 110 of the strings 102, 116 can thus be lit.

As illustrated in FIG. 1, the light strings 102, 116 are disposed or installed about the tree 118 in a circumferential arrangement that is taut in relation to or about the tree 118 so that the light strings 102, 116 do not droop and can maintain their arrangement after the installation. In this arrangement, the one or more breakaway bands 108, 114 are applied to the wiring 106, 112 at a predetermined distance below the associated one or more light elements 104, 110 (e.g., light sockets) and are configured to provide expandability to the at least one light string 102, 116 as the tree 118 grows circumferentially, including its trunk and branches. The predetermined distance can vary based on particular requirement, such as an estimated service life for the installation (e.g., before removal) and an associated expandability that might be required. While in one implementation the distance of a breakaway band 108, 114 below an associated light elements 104, 110 can be a ½ of an inch, other distances can be considered based on a total number of the breakaway bands 108, 114 provided in the light string 102, 116 and a total slack that can be let out as the tree 118 grows.

In particular, as the tree 118 grows circumferentially, one or more of the breakaway bands 108, 114 will break, allowing built-in slack formed between the light elements 104, 110 and the respective breakaway bands 108, 114 to be let out circumferentially about the tree 118, thus extending the lights strings 102, 116. As the lights strings 102, 116 will have some rigidity over time, the built-in slack will splay circumferentially about the tree 118 in a fairly controlled manner, thus maintaining the circumferential arrangement that is taut in relation to or about the tree 118 so that the light strings 102, 116 expand yet do not droop and can maintain their arrangement after the installation.

As described herein, the breakaway bands 108, 114 are configured to break. In particular, as the tree 118 grows and provides a force outwardly on the light string 102, 116, one or more the breakaway bands 108, 114 will break at one or more different times. The breakaway bands 108, 114 are inexpensive to manufacture, simple and reliable to add to the light strings 102, 116, provide for efficiency in a method of installation of the light strings 102, 116, and allow portions of the light strings 102, 116 (e.g., between the light sockets and the breakaway bands) to have slack while reducing the overall length of the light strings 102, 116 so that they can be initially mounted or installed to the tree 118 in a taut arrangement, and further allow the light strings 102, 116 to expand as the tree 118 grows over multiple seasons, without injuring the tree or requiring significant labor to remove the light strings 102, 116 after the multiple seasons of growth.

FIG. 2 illustrates a close-up view of breakaway bands 108, 114 according to respective first and second embodiments, as applied to wiring 106, 112 below associated light elements 104, 110 of the light strings 102, 116 in accordance with FIG. 1. It should be noted that while only a portion of the light string 102 is shown as applied in relationship a portion 222 of the tree 118 for brevity and clarity, the description applies equally to the light strings 102, 116 applied to the tree 118, including its trunk and one or more branches.

As illustrated in FIG. 2, the light strings 102, 116 have a plurality of light elements 104, 110 that can be powered and which produce respective light 206, 214. The light elements 104, 110 include respective sockets 202, 210 that hold and provide power to respective bulbs or LEDs 204, 212, which produce respective light 206, 214.

In a first embodiment, one or more of the light strings 102, 116 includes one or more breakaway bands 108 according to a first embodiment. As described herein, the one or more breakaway bands 108 are applied to the wiring 106 at a predetermined distance (e.g., ½ inch) below the associated one or more light elements 104 (e.g., below light socket 202 holding lightbulb/LED 204) and are configured to provide expandability to the at least one light string 102, 116 as the tree 118 grows circumferentially.

In the first embodiment, a breakaway band 108 includes one perforation 208. In this arrangement, the one or more breakaway bands 108, 114 are applied to the wiring 106, 112 at a predetermined distance below the associated one or more light elements 104, 110 (e.g., light sockets) and are configured to provide expandability to the at least one light string 102, 116 as the tree 118 grows circumferentially, including its trunk and branches. The perforation 208 extends along a width of the breakaway band 108 and is located approximately centrally along a length of the breakaway band 108. The location of the perforation 208 is not limited, and thus the perforation 208 can be located at one or more other positions along the length of the breakaway band 108.

In a second embodiment, one or more of the light strings 102, 116 includes one or more breakaway bands 114 according to a second embodiment. As described herein, the one or more breakaway bands 114 are applied to the wiring 112 at a predetermined distance (e.g., ½ inch) below the associated one or more light elements 104 (e.g., below light socket 210 holding lightbulb/LED 212) and are configured to provide expandability to the at least one light string 102, 116 as the tree 118 grows circumferentially.

In the second embodiment, there are provided a plurality of perforations. For example, three (3) perforations 216, 218, and 220 are provided in the breakaway band 114. More or fewer perforations can of course be provided. The perforations 216-220 extend along a width of the breakaway band 108, and they are spaced approximately centrally and equidistantly along a length of the breakaway band 114. The locations and spacing of the perforations 216-220 are not limited, and thus the perforations 216-220 can have one or more other spacings and be located at one or more other positions along the length of the breakaway band 114.

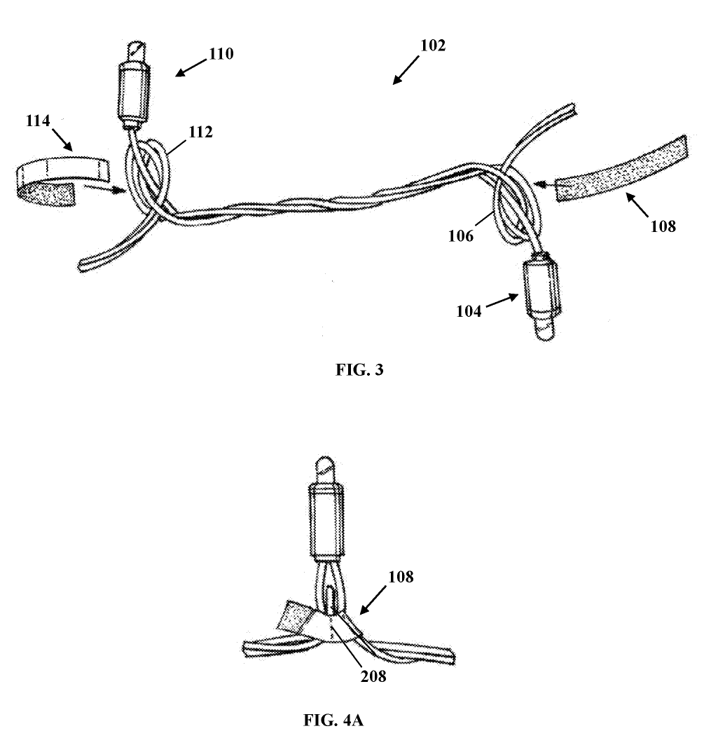

FIG. 3 illustrates an exploded view of several breakaway bands 108, 114 according to the first and second embodiments, being applied to the wiring 106, 112 of associated light elements 104, 110 (e.g., light sockets 202, 210 holding lightbulbs/LEDs 204, 212) of the at least one light string 102, 116 in accordance with FIG. 1.

As particularly illustrated in FIG. 3, the breakaway bands 108, 114 are applied to the wiring 106, 112 at a predetermined distance (e.g., approximately ½ inch, etc.) below the associated one or more light elements 104, 110 (e.g., below the light sockets 202, 210 holding the lightbulbs/LEDs 204, 212) and are configured to provide expandability to the at least one light string 102, 116 as the tree 118 grows circumferentially.

In particular, the breakaway bands 108, 114 include an adhesive disposed on at least a portion of the breakaway bands 108, 114 so that the breakaway bands 108, 114 can be applied to and secured about the wiring 106, 112 at the predetermined distance below the associated one or more light elements 104, 110. In some cases, the portion of the breakaway bands 108, 114 can be coated with an adhesive, while in other cases, an adhesive tape can be applied to the portion of the breakaway bands 108, 114.

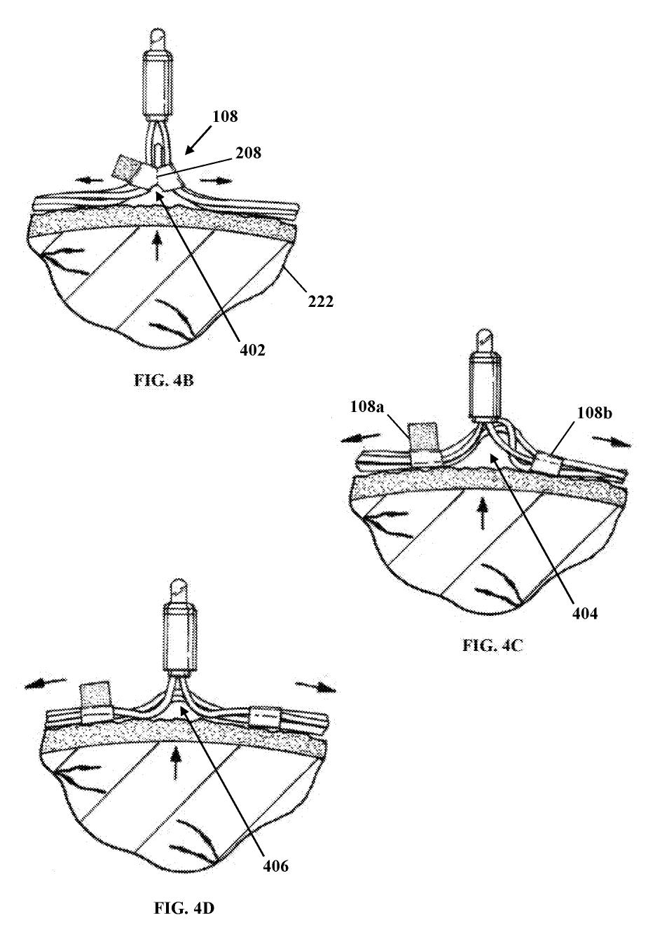

FIGS. 4A-4D illustrate the operation of a breakaway band 108 according to the first embodiment, as applied to the wiring 106 of an associated light element 104 (e.g., light socket 202) of the at least one light string 102, 116 in accordance with FIGS. 1-3.

As illustrated in FIG. 4A, the light strings 102, 116 are mounted to or installed about the tree 118 in one or more arrangements, with one or more of the breakaway bands 108 applied to the wiring 106 at a predetermined distance (e.g., approximately ½ inch, etc.) below one or more of the associated light elements 104 (e.g., below the light sockets 202 holding the lightbulbs/LEDs 204). In particular, the breakaway band 108 includes a single perforation 208.

As the tree 118 grows circumferentially over time (e.g., one or more seasons), it produces a force outwardly on the light strings 102, 116 as indicated by an up-arrow. As illustrated at location 402 in FIG. 4B, the force causes the perforation 208 of one or more of the applied breakaway bands 108 to start tearing along the perforation 208, providing a controlled breaking, tearing, or separation along the perforation 208, and splaying of the slack 106 circumferentially about the tree 118 as indicated by left-and-right arrows, in a fairly controlled manner, thus maintaining the circumferential arrangement that is taut in relation to or about the tree 118 so that the light strings 102, 116 expand yet do not droop with time.

As further illustrated at location 404 in FIG. 4C, over time the force indicated by the up-arrow continues to increase and causes the perforation 208 of one or more of the applied breakaway bands 108 to continue tearing along the perforation 208 until breakaway bands 108 completely separates along the perforation 208, and the slack 106 continues to splay circumferentially about the tree 118 as indicated by left-and-right arrows. The breakaway band 108 can separate into one or more pieces 108a, 108b that can continue to adhere to the light strings 102, 116 via the adhesive or adhesive tape, and/or upon separation or at some time later fall away from the light strings 102, 116.

Lastly, as illustrated at location 406 in FIG. 4D, over a further time the force indicated by the up-arrow continues to increase and cause the remaining slack 106 to splay circumferentially about the tree 118 as indicated by left-and-right arrows, until the slack 106 is exhausted. Based on the slack of each breakaway band 108 (e.g., ½ inch) and a total number of the breakaway bands 108 as applied to the light strings 102, 116, a total amount of slack provided can be considerable, thus allowing splaying of the light strings 102, 116 in a fairly controlled manner as the tree 118 grows over multiple seasons, thus maintaining the circumferential arrangement of the light strings 102, 116 about the tree 118, and facilitating removal for the light strings 102, 116 while mitigating embedding and resulting injury to the tree 118.

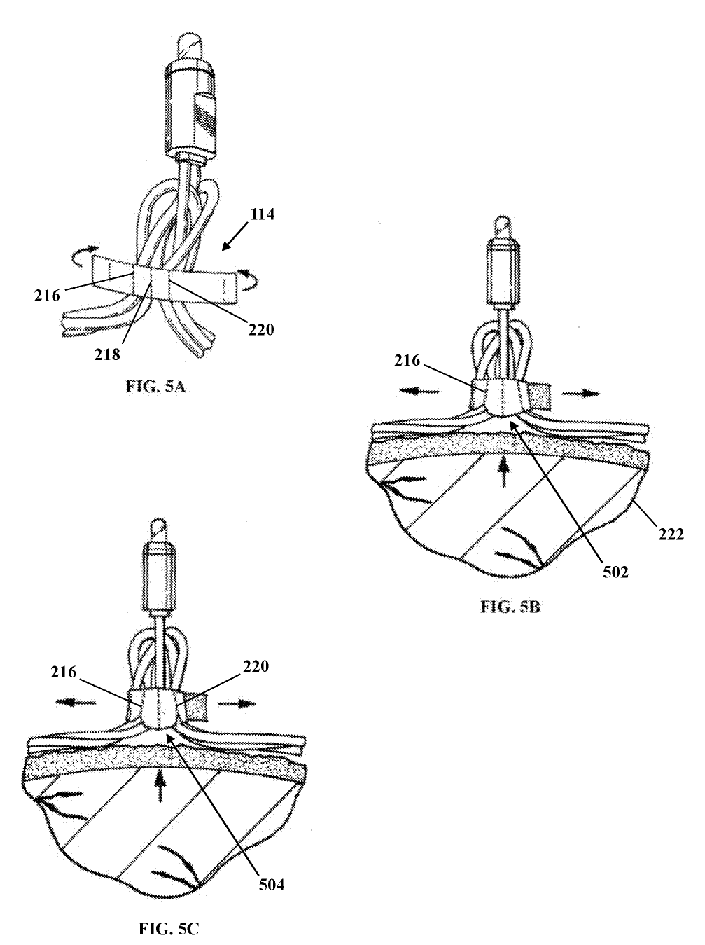

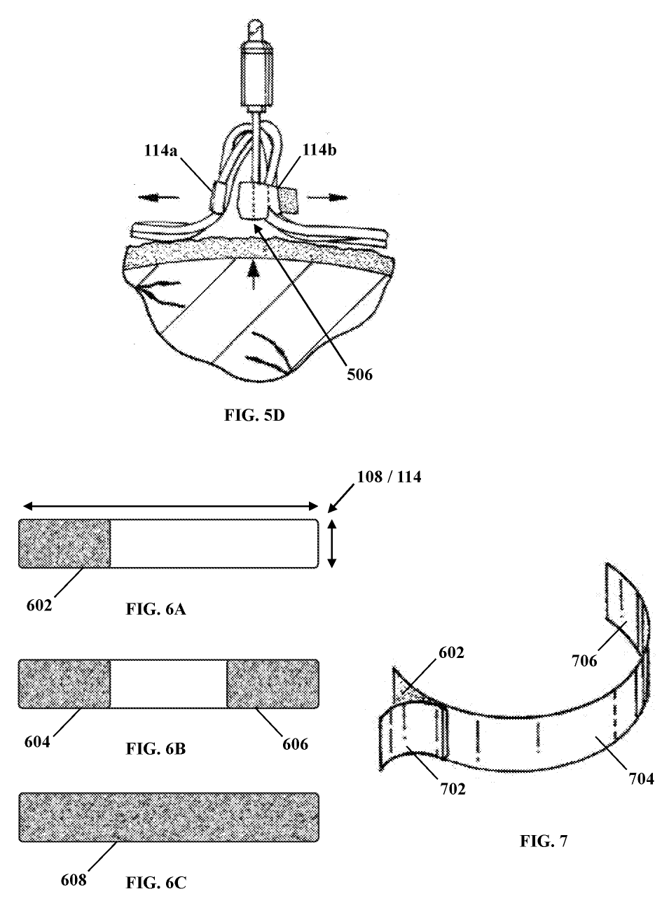

FIGS. 5A-5D illustrate the operation of a breakaway band 114 according to the second embodiment, as applied to the wiring 112 of an associated light 110 (e.g., light socket 210) of the at least one light string 102, 116 in accordance with FIGS. 1-3.

As illustrated in FIG. 5A, the light strings 102, 116 are mounted or installed about the tree 118 in one or more arrangements, with one or more of the breakaway band 114 applied to the wiring 112 at a predetermined distance (e.g., approximately ½ inch, etc.) below one or more of the associated lights 110 (e.g., below the light sockets 210 holding the lightbulbs/LEDs 212). In particular, the breakaway band 114 includes a plurality of perforations, for example, perforations 216, 218, and 220.

As already described hereinabove, when the tree 118 grows circumferentially over time (e.g., one or more seasons), it produces a force outwardly on the light strings 102, 116 as indicated by an up-arrow in FIGS. 5B-5D. As particularly illustrated at location 502 in FIG. 5B, the force causes one or more of the perforations (e.g., perforation 216) of one or more of the applied breakaway bands 114 to start tearing along the perforation 216, providing a controlled breaking, tearing, or separation along the perforation 216, and splaying of the slack 112 circumferentially about the tree 118 as indicated by left-and-right arrows, in a fairly controlled manner, thus maintaining the circumferential arrangement that is taut in relation to or about the tree 118 so that the light strings 102, 116 expand yet do not droop with time. It should be noted that, while tearing is only illustrated along the example perforation 216, any one or more of the perforations 216-220 of the breakaway bands 114 can start tearing upon the force being applied by the tree 118 to the light strings 102, 116.

As further illustrated at locations 504 in FIG. 5C, over time the force indicated by the up-arrow continues to increase and causes one or more perforations 216, 220 of one or more of the applied breakaway bands 114 to continue tearing along the perforations 216, 220. It should be noted that, while tearing is only illustrated along the example perforations 216, 220, any one of more of the perforation 216-220 of the breakaway bands 114 can tear upon force being applied by the tree 118 to the light strings 102, 116. The continued tearing provides a controlled separation along the perforations 216-220, and resultant splaying of the slack 112 circumferentially about the tree 118 as indicated by left-and-right arrows, in a fairly controlled manner, thus maintaining the circumferential arrangement that is taut in relation to or about the tree 118 so that the light strings 102, 116 expand yet do not droop with time.

Lastly, as illustrated at location 506 in FIG. 5D, over a further time the force continues until breakaway bands 114 completely separate along a perforation 216 of the one or more of the perforations 216-220, and the slack 112 continues to splay circumferentially about the tree 118 as indicated by left-and-right arrows. The breakaway band 108 can separate into one or more pieces 114a, 114b that can continue to adhere to the light strings 102, 116 via the adhesive or adhesive tape, and/or upon separation or at some time later fall away from the light strings 102, 116.

As already described hereinabove, based on the slack of each breakaway band 114 (e.g., ½ inch) and a total number of the breakaway bands 114 as applied to the light strings 102, 116, a total amount of slack provided can be considerable, thus allowing splaying of the light strings 102, 116 in a fairly controlled manner as the tree 118 grows over multiple seasons, thus maintaining the circumferential arrangement of the light strings 102, 116 about the tree 118, and facilitating removal for the light strings 102, 116 while mitigating embedding and resulting injury to the tree 118.

It should be noted that a certain light string of the light strings 102, 116 can include only one or more breakaway bands 108 according to the first embodiment, only one or more breakaway bands 114 according to the first embodiment, or a combination of breakaway bands 108, 114 according to the first and the second embodiments.

FIGS. 6A-6C illustrates a breakaway band 108, 114 according to the first embodiment or the second embodiment, with an adhesive disposed on at least one portion 602, 604-606, or 608 of the breakaway band 108, 114 configured to allow the breakaway band to be securely attached about the wiring 106, 112 of an associated light element 104, 114 (light socket 202, 210) of the at least one light string 102, 116 in accordance with FIGS. 1-5D.

As illustrated in FIG. 6A, each of the breakaway bands 108, 114 includes a length and a width. For example, the length can be in a range of ½ of an inch to 2½ inches, and in one example the length is ½ of an inch, and the width can be in a range of ⅛ of an inch to ½ of inch, and in one example the width is ⅜ of an inch. Moreover, the thickness of the breakaway band 108, 114 can be in a range of 1 mil. to 3.5 mil. (mil.=1/1000 of an inch), and in one example, the thickness is 2.4 mil. It should be noted that the breakaway band 108, 114 can be made to include different dimensions and/or thicknesses, as may be desired or required for various applications.

As illustrated in FIGS. 6A-6C, an adhesive can be disposed on at least one portion 602, 604-606, or 608 of the breakaway bands 108, 114, and configured to allow the breakaway band to be securely attached about the wiring 106, 112 of an associated light element 104, 114 (light socket 202, 210) of the at least one light string 102, 116. In particular, an adhesive portion 602 can be provided at one end of the breakaway band, and can adhere to the other end of the breakaway band, either on the same side (front) or the opposite side (back) of the breakaway band. Adhesives portions 604, 606 can be provided at both ends of the breakaway band, and can adhere to each on the same side (front) of breakaway band, or the adhesive portion 604 can adhere to wiring 106, 112 and the adhesive portion 606 can wrap around and adhere to the opposite side (back) of the breakaway band. Adhesive portion 608 can be provided along an entirety of the breakaway band (front), and both ends can adhere to each on the same side (front) of the breakaway band, or the adhesive portion 608 can adhere to wiring 106, 112 as it wrap arounds and adheres to the opposite side (back) of the breakaway band.

The breakaway band 108, 114 can be a tape that is made of a polyvinyl chloride (PVC), another thermoplastic material (e.g., polypropylene), or rubber material (e.g., thermoplastic rubber-TPE and thermoplastic elastomer-TPR). The breakaway band 108, 114 can also be made from a plastic film, paper, or cloth. In particular, PVC generally offers a combination of desirable characteristics for breakaway band 108, 114, such as durability, flexibility, weather resistance, while providing limited stretch characteristics, which might be preferable for the breakaway band 108, 114, so that upon the applied force the breakaway band 108, 114 does not stretch, but rather tears along one or more of the perforations 208 and/or 216-220.

FIG. 7 illustrates a breakaway band 108, 114 according to the first embodiment or the second embodiment, with an adhesive disposed on at least a portion 602 of the breakaway band 108, 114 configured to allow the breakaway band to be securely attached about the wiring 106, 112 of an associated light element 104, 114 (light socket 202, 210) of the at least one light string 102, 116 in accordance with FIGS. 1-5D, and a removable cover 702 configured to expose the adhesive when affixing the breakaway band 108, 114 to the wiring 106, 112 of an associated light 104, 114 (light socket 202, 210).

As illustrated in FIG. 7, an adhesive can be disposed on at least one portion 602, of the breakaway bands 108, 114, and configured to allow the breakaway band to be securely attached about the wiring 106, 112 of an associated light 104, 114 (light socket 202, 210) of the at least one light string 102, 116. In particular, the adhesive portion 602 can be provided at one end of the breakaway band, and can adhere to the other end of the breakaway band, either on the same side 704 or the opposite side 706 of the breakaway band 108, 114.

In operation, the removable cover 702 can be peeled off to expose the adhesive of the at least one portion 602 of FIG. 6A when affixing the breakaway band 108, 114 to the wiring 106, 112 of the associated light 104, 114 (light socket 202, 210). It should be noted a similar removable cover (not shown) can be provided to cover the adhesive of the portions 604-606 in FIG. 6B and the adhesive of the portion 608 in FIG. 6C.

Thus, there have been described herein breakaway bands for tree lighting and a tree lighting system that includes one or more light strings each with one or more breakaway bands to provide expandability of the light strings. Although specific example embodiments or aspects have been described, it will be evident that various modifications and changes may be made to these embodiments or aspects without departing from the broader scope of the invention. Accordingly, the specification and drawings are to be regarded in an illustrative rather than a restrictive sense. The accompanying drawings that form a part hereof, show by way of illustration, and not of limitation, specific embodiments or aspects in which the subject matter may be practiced. The embodiments or aspects illustrated are described in sufficient detail to enable those skilled in the art to practice the teachings disclosed herein. Other embodiments or aspects may be utilized and derived therefrom, such that structural and logical substitutions and changes may be made without departing from the scope of this disclosure. This Detailed Description, therefore, is not to be taken in a limiting sense, and the scope of various embodiments or aspects is defined only by the appended claims, along with the full range of equivalents to which such claims are entitled.

Such embodiments or aspects of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments or aspects have been illustrated and described herein, it should be appreciated that any arrangement calculated to achieve the same purpose may be substituted for the specific embodiments or aspects shown. This disclosure is intended to cover any and all adaptations or variations of various embodiments or aspects. Combinations of the above embodiments or aspects, and other embodiments or aspects not specifically described herein, will be apparent to those of skill in the art upon reviewing the above description

The Abstract is provided to allow the reader to quickly ascertain the nature and gist of the technical disclosure. It is submitted with the understanding that it will not be used to interpret or limit the scope or meaning of the claims.

In the foregoing description of the embodiments or aspects, various features are grouped together in a single embodiment for the purpose of streamlining the disclosure. This method of disclosure is not to be interpreted as reflecting that the claimed embodiments or aspects have more features than are expressly recited in each claim. Rather, as the following claims reflect, inventive subject matter lies in less than all features of a single disclosed embodiment or aspect. Thus each claim stands on its own as a separate example embodiment or aspect. It is contemplated that various embodiments or aspects described herein can be combined or grouped in different combinations that are not expressly noted in the Detailed Description. Moreover, it is contemplated that claims covering such different combinations can similarly stand on their own as separate example embodiments or aspects.

1. A tree lighting system comprising:
a light string having a length, the light string comprising power wires connecting a plurality of light sockets, the plurality of light sockets configured to hold and provide power from the power wires to a respective plurality of light elements configured to emit light when powered; and
a breakaway band disposed about the power wires at a predetermined distance below a light socket of the plurality of light sockets, thus providing a slack portion of the power wires between the breakaway band and the light socket, the slack portion reducing the length of the light string, the breakaway band comprising at least one perforation that upon exertion of force breaks and is configured to allow the slack portion to splay thus extending the light string toward its length.

2. The tree lighting system according to claim 1, wherein the light string is configured to be disposed about a live tree.

3. The tree lighting system according to claim 2, wherein the live tree exerts the force on the least one perforation of the breakaway band.

4. The tree lighting system according to claim 1, wherein the at least one perforation of the breakaway band includes one perforation.

5. The tree lighting system according to claim 1, wherein the at least one perforation of the breakaway band includes three perforations.

6. The tree lighting system according to claim 5, wherein the three perforations are equidistantly spaced along the breakaway band.

7. The tree lighting system according to claim 1, wherein a light element is a lightbulb or a light emitting diode.

8. The tree lighting system according to claim 1, wherein the breakaway band comprises an adhesive disposed at one or more portions of the breakaway band so that the breakaway band is capable of being secured about the power wires at the predetermined distance below the light socket.

9. The tree lighting system according to claim 1, wherein the breakaway band comprises a removable cover configured to expose the adhesive disposed at the one or more portions.

10. The tree lighting system according to claim 1, wherein the breakaway band has a length and a width.

11. The tree lighting system according to claim 1, wherein the length is in a range of ½ of inch to 2½ inches, and the width is in a range of ⅛ of an inch to ½ of an inch.

12. The tree lighting system according to claim 1, wherein the breakaway band has thickness.

13. The tree lighting system according to claim 1, wherein the thickness is in a range of 1 mil. to 3.5 mil.

14. The tree lighting system according to claim 1, wherein the breakaway band is made of polyvinyl chloride, thermoplastic, rubber, plastic film, paper, or cloth.

15. A breakaway band for a tree lighting string including power wires connecting a plurality of light sockets, the plurality of light sockets configured to hold and provide power from the power wires to a respective plurality of light elements configured to emit light when powered, the breakaway band having a length and a width, the breakaway band comprising:
at least one perforation extending along the width and located centrally along the length; and
an adhesive disposed at one or more portions along the length of the breakaway band, so that the breakaway band is capable of being secured about the power wires at a predetermined distance below a light socket providing a slack portion of the power wires between the breakaway band and the light socket, wherein upon exertion of force to the at least one perforation the breakaway band is configured to break thus allowing the slack portion to splay and extend the light string.

16. The breakaway band according to claim 15, wherein the breakaway band comprises a removable cover configured to expose the adhesive disposed at the one or more portions.

17. The breakaway band according to claim 15, wherein the length is in a range of ½ of an inch to 2½ inches, and the width is in a range of ⅛ of an inch to ½ of an inch.

18. The breakaway band according to claim 15, wherein the breakaway band has thickness in a range of 1 mil. to 3.5 mil.

19. The breakaway band according to claim 15, wherein the at least one perforation of the breakaway band includes three perforations.

20. The breakaway band according to claim 19, wherein the three perforations are equidistantly spaced along the length of the breakaway band.
